(19) United States
(12) Patent Application Publication
(10) Pub. No.: US 2025/0194647 A1
(43) Pub. Date: Jun. 19, 2025

(54) SOFT GEL PRODUCT OF SURIMI AND PREPARATION METHOD THEREOF

(71) Applicant: BOHAI UNIVERSITY, Jinzhou City (CN)

(72) Inventors: Xuepeng LI, Jinzhou City (CN); Qingxin LI, Jinzhou City (CN); Yanwei LIU, Jinzhou City (CN); Jinxiang WANG, Jinzhou City (CN); Jianrong LI, Jinzhou City (CN); Zhen LI, Jinzhou City (CN); Ning LU, Dalian (CN); Guangren JI, Jinzhou City (CN); Xiaomin ZHOU, Zhoushan City (CN); Qing YANG, Rongcheng City (CN); Zhengpeng WEI, Rongcheng City (CN)

(73) Assignee: BOHAI UNIVERSITY, Jinzhou City (CN)

(21) Appl. No.: 18/772,639

(22) Filed: Jul. 15, 2024

(30) Foreign Application Priority Data
Dec. 14, 2023 (CN) 202311723015.6

(51) Int. Cl. A23L 17/00; A23D 7/005; A23D 7/04; A23L 29/212

(52) U.S. Cl. CPC A23L 17/65; A23D 7/0053; A23D 7/04; A23L 29/212

(57) ABSTRACT

A soft gel product of surimi and a preparation method thereof are provided in the present disclosure, belonging to the technical field of aquatic products, and including surimi, alkaline protease, fish oil Pickering emulsion and auxiliary materials. The preparation method includes the following steps: thawing the surimi, then adding protease for pounding for 2 to 4 minutes, then adding salt for pounding for another 2 to 4 minutes, and then adding Pickering emulsion and remaining auxiliary materials to continue pounding for 3 to 5 minutes, and finally, molding the surimi, gelatinizing the surimi by two-stage heating, and cooling to obtain the soft gel product of surimi.

### CROSS-REFERENCE TO RELATED APPLICATIONS

This application claims priority to Chinese Patent Application No. 202311723015.6, filed on Dec. 14, 2023, the contents of which are hereby incorporated by reference.

### TECHNICAL FIELD

The present disclosure belongs to the technical field of aquatic products, and in particular to a soft gel product of surimi and a preparation method thereof.

### BACKGROUND

Dysphagia is the feeling of obstruction and stagnation in the pharynx, retrosternum, or esophagus due to the obstruction of the transportation of food from the oral cavity to the stomach and cardia, and it is a common geriatric syndrome and one of the complications of stroke and other diseases, which is a serious threat to the life, health, and well-being of the elderly and other people who suffer from dysphagia. By modifying the food form and making food into food gel, the problem of choking on food for dysphagia patients is effectively reduced, and the patients are not only supplemented with water and nutrients, but also trained in swallowing function. Therefore, the intake of soft gel products is an effective way of nutritional support suitable for people with dysphagia.

Surimi products are popular among consumers for the high quality of aquatic proteins and their high viscoelasticity. In recent years, the surimi products industry has made great progress, developed from some single species such as squid ball, shrimp ball to mechanized production of a series of new high-grade surimi products and frozen prepared food, such as fish sausage, fish sausage, simulated crab meat, simulated shrimp, simulated scallop columns, fish cake, Chikuwa and so on. However, with the enhancement of health consciousness among people, it is difficult for the existing types of surimi products to satisfy the higher demands of consumers for nutritional and functional values, especially for special groups such as the elderly and people with dysphagia. The relatively high hardness, elasticity, and chewiness of surimi gel products are difficult to be consumed by people with special needs, such as the elderly and those with dysphagia, and therefore, the development of a soft-gel surimi product is required.

There have been preparations of soft gel products of fish in the prior art, but most of them use three basic amino acids, arginine, lysine and histidine, to reduce the degree of aggregation of myosin or fish protein to obtain soft gels of fish proteins, and the above raw materials have problems such as adding limitations in actual production.

Therefore, it is a technical problem for the technicians in the field to overcome the difficulties of the existing technology that the higher hardness, elasticity, and chewability of surimi products are hardly suitable for consumption by special groups of people with dysphagia to supplement high-quality aquatic animal proteins, and to provide a soft gel product of surimi that is suitable for industrialized production, as well as high-protein, high-nutrition, and easy-to-consume products suitable for consumption by special groups of people such as patients with dysphagia.

### SUMMARY

In order to solve the technical problems, the present disclosure provides a soft gel product of surimi and a preparation method thereof.

In order to achieve the above objectives, the present disclosure provides the following technical schemes.

A soft gel product of surimi, including surimi, alkaline protease, fish oil Pickering emulsion and auxiliary materials.

Optionally, a mass ratio of the surimi, alkaline protease and fish oil Pickering emulsion is 100:(0.05-0.15):(1.5-6).

Optionally, the auxiliary materials include salt, soy protein isolate, egg white powder, vegetable oil and starch, and a mass ratio of the salt, soy protein isolate, egg white powder, vegetable oil, potato starch and surimi is 1.5:0.5:1:2:10:100.

Optionally, the surimi is one or more of silver carp surimi, golden threadfin bream surimi, snapper surimi, belt fish surimi and baby croaker surimi, preferably silver carp surimi.

Optionally, a preparation method of the fish oil Pickering emulsion includes the following steps:

mixing a fish oil and a modified starch dispersion according to an oil-water ratio of 0.5 w/w, adjusting an ionic strength using a sodium chloride solution, followed by homogenizing treatment to obtain the fish oil Pickering emulsion.

Optionally, the modified starch includes one of sodium octenyl succinate corn starch, sodium octenyl succinate cassava starch, cross-linked cassava starch, acetate cassava starch, hydroxypropyl cassava starch and hydroxypropyl phosphate corn starch.

Optionally, a concentration of the modified starch dispersion is 4%.

A concentration of the sodium chloride solution is 0.4 Mole per liter (mol/L).

The homogenizing treatment includes: firstly, treating using a high-speed homogenizer at 15,000 revolutions per minute (r/min) for 4 min, and then homogenizing by a high-pressure homogenizer at 50 Megapascals (MPa) for 8 times.

Optionally, a water content of the soft gel product of surimi is 75%-85%, and preferably 78%.

A preparation method of the soft gel product of surimi, including following steps:

thawing the surimi, then adding protease for pounding for 2 to 4 min, then adding salt for pounding for another 2 to 4 min, and then adding Pickering emulsion and remaining auxiliary materials to continue pounding for 3 to 5 min, and finally, molding the surimi, gelatinizing the surimi by two-stage heating, and cooling to obtain the soft gel product of surimi.

Optionally, the thawing is carried out at 4 degrees Celsius (C) for 12 hours (h).

Optionally, a temperature of the pounding is 0-10° C.; and
the two-stage heating includes: heating at 40° C. for 20 min, then heating to 90° C. and heating for 30 min.

Compared with the prior art, the present disclosure has the following advantages and technical effects.

The strength of the surimi gels of the present disclosure with the addition of protease and Pickering emulsion undergoes softening to varying degrees. This is due to the fact that the addition of protease leads to the enzymatic digestion of some of the proteins in the surimi gel, and the concentration of proteins involved in the gel is reduced, which in turn reduces the gel strength of the surimi product. The addition of fish oil Pickering emulsion on the one hand prevents the cross-linking of proteins and further reduces the gel strength of surimi; on the other hand, the filling effect of Pickering emulsion further improves the quality of surimi soft gels, and the prepared soft gel product of surimi is more suitable for patients with dysphagia and other special populations.

The fish oil added in the present disclosure is rich in n-3 polyunsaturated fatty acids, such as EPA and DHA, which have the functions of lowering cholesterol and promoting brain health, and may improve the nutritional and health value of soft gel product of surimi, and is more suitable for nutritional supplement of the elderly and people with dysphagia.

### BRIEF DESCRIPTION OF THE DRAWINGS

The accompanying drawings, which constitute a part of this application, are used to provide a further understanding of this application. The illustrative embodiments of this application and their descriptions are used to explain this application, and do not constitute an improper limitation of this application. In the attached drawings:

FIG. 1 is a microstructure diagram of modified starch-based fish oil Pickering emulsion prepared in Embodiment 1;

FIG. 2 shows the gel strength of Pickering emulsion soft gel products of surimi with different addition amounts in Embodiments 1-6;

among them, CK and 1.5% fish oil are the blank control group and the control group added with 1.5% fish oil respectively;

FIG. 3 is the microstructure diagram of Pickering emulsion soft gel products of surimi with different addition amounts in Embodiments 1-6 at 5000 times; among them, A-F correspond to CK, 1.5% fish oil, Embodiment 1, Embodiment 2, Embodiment 3 and Embodiment 4 respectively;

FIG. 3A shows the microstructure diagram of Pickering emulsion surimi soft gel of CK group;

FIG. 3B shows the microstructure diagram of surimi soft gel with the addition of 1.5% fish oil;

FIG. 3C shows the microstructure diagram of surimi soft gel with the addition of 1.5% Pickering emulsion (Embodiment 1);

FIG. 3D shows the microstructure diagram of surimi soft gel with the addition of 3% Pickering emulsion (Embodiment 2);

FIG. 3E shows the microstructure diagram of surimi soft gel with the addition of 4.5% Pickering emulsion (Embodiment 3);

FIG. 3F shows the microstructure diagram of surimi soft gel with the addition of 6% Pickering emulsion (Embodiment 4);

FIG. 4 shows the water holding capacity of Pickering emulsion surimi soft gel with different addition amounts in Embodiments 7-12;

FIG. 5A shows the rheological property of viscosity of Pickering emulsion surimi soft gel with different addition amounts in Embodiments 7-12;

FIG. 5B shows the storage modulus and loss modulus of Pickering emulsion surimi soft gel with different addition amounts in Embodiments 7-12;

FIG. 6 shows the molecular force of Pickering emulsion surimi soft gel with different addition amounts in Embodiments 13-18.

### DETAILED DESCRIPTION OF THE EMBODIMENTS

In the following, the technical schemes in the embodiments of the present disclosure are clearly and completely described with reference to the attached drawings. Obviously, the described embodiments form only a part of the embodiments of the present disclosure, but not the whole embodiments. Based on the embodiments in the present disclosure, all other embodiments obtained by ordinary technicians in the field without creative labor belong to the scope of protection of the present disclosure.

In order to make the above objectives, features and advantages of the present disclosure more obvious and easier to understand, the present disclosure will be further described in detail with the attached drawings and specific embodiments.

The raw materials in the embodiments of the present disclosure are all obtained by commercial means.

### Embodiment 1

A preparation method of a soft gel product of surimi, including the following steps.

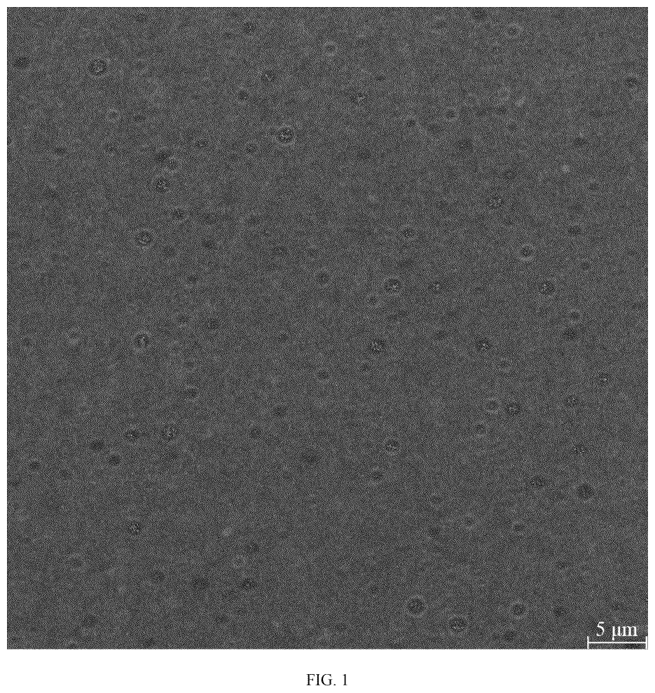

(1) Preparation of fish oil Pickering emulsion: sodium octenyl succinate corn starch is weighed and dissolved in distilled water at 50° C. to prepare a modified starch dispersion with a concentration of 4%; then a certain mass of silver carp fish oil is weighed, and the fish oil is added to the modified starch dispersion according to an oil-water ratio of 0.5 (w/w), and an ionic strength is adjusted to 0.4 Mole per liter (mol/L) with sodium chloride, followed by treating with a high-speed homogenizer at 15,000 revolutions per minute (r/min) for 4 min, then homogenizing with a high-pressure homogenizer (homogenization pressure of 50 Megapascals (MPa), and circulation times of 8 times) to obtain a fish oil Pickering emulsion; the microstructure of the fish oil Pickering emulsion is shown in FIG. 1. It is observed that the emulsion droplets form a compact interfacial film structure, and the oil droplets are evenly distributed without flocculation and aggregation, indicating that the emulsion structure is stable.

(2) Surimi thawing and pounding: the frozen surimi of silver carp is thawed in a cold storage or refrigerator at 4° C. for 12 h, then 0.1% alkaline protease is added to the thawed surimi below 10° C. and subjected to pounding for 2 min, then salt is added and subjected to pounding for another 2 min, and finally 1.5% (i.e., the mass fraction of the Pickering emulsion in the surimi is 1.5%) of the Pickering emulsion obtained in step (1) is added, as well as the auxiliary ingredients, including soy protein isolate, egg white powder, vegetable oil, potato starch, and so on, to continue pounding for 3 min;
among them, the addition amounts of salt, soy protein isolate, egg white powder, vegetable oil and potato starch are 1.5%, 0.5%, 1%, 2% and 10% of the weight of surimi, respectively.

(3) Molding and gelatinizing: firstly, the molded surimi is heated at 40° C. for 20 min, then heated to 90° C. for heating of 30 min to gelatinize the surimi, and finally, the soft gel product of surimi is obtained after by cooling, packaging, freezing and frozen storage.

### Embodiment 2

The present embodiment relates to a preparation method of a soft gel product of surimi, which is different from Embodiment 1 only in that the sodium octenyl succinate corn starch in step (1) is replaced with the equivalent sodium alkenyl succinate cassava starch to prepare Pickering emulsion; and 3% Pickering emulsion obtained in step (1) is added in step (2).

The remaining steps and parameters are the same as those in Embodiment 1.

### Embodiment 3

The present embodiment relates to a preparation method of a soft gel product of surimi, which is different from Embodiment 1 only in that the sodium octenyl succinate corn starch in step (1) is replaced with the same amount of cross-linked cassava starch to prepare Pickering emulsion; and in step (2), 4.5% of Pickering emulsion obtained in step (1) is added.

The remaining steps and parameters are the same as those in Embodiment 1.

### Embodiment 4

The present embodiment relates to a preparation method of a soft gel product of surimi, which is different from Embodiment 1 only in that the sodium octenyl succinate corn starch in step (1) is replaced with the equivalent amount of acetate cassava starch to prepare Pickering emulsion;

and 6% Pickering emulsion obtained in step (1) is added in step (2).

The remaining steps and parameters are the same as those in Embodiment 1.

### Embodiment 5

The present embodiment relates to a preparation method of a soft gel product of surimi, which is different from Embodiment 1 only in that the sodium octenyl succinate corn starch in step (1) is replaced with the same amount of hydroxypropyl cassava starch to prepare Pickering emulsion; and in step (2), the Pickering emulsion obtained in step (1) is not added.

The remaining steps and parameters are the same as those in Embodiment 1.

### Embodiment 6

The present embodiment relates to a preparation method of a soft gel product of surimi, which is different from Embodiment I only in that 1.5% Pickering emulsion in step (2) is replaced with 1.5% silver carp oil.

The remaining steps and parameters are the same as those in Embodiment 1.

### Technical Performance

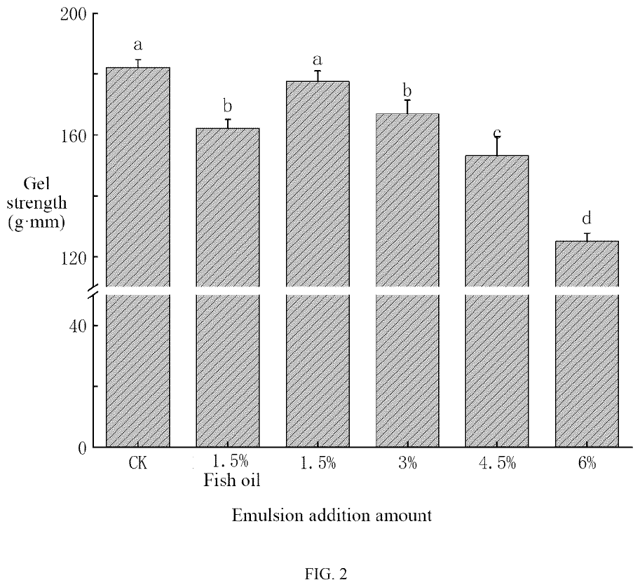

1. Determination of gel strength: using the TA.XT.Plus texture analyzer produced by Stable Micro Systems, UK, probe P5s is selected for puncture mode determination. The trigger force is 5.0 g, the pre-test speed is 5 mm/s, the mid-test speed is 1 mm/s, the post-test speed is 1 mm/s, and the puncture distance is 10 mm. The breaking force (g) and depth of depression (mm) of soft gel products of surimi of Embodiments 1-6 with different masses of Pickering emulsion added are tested, with gel strength (g·mm)=gel breaking force (g) x depth of depression (mm). The gel strengths of the soft gel products of surimi obtained in Embodiments 1-6 are 177.51+3.45 g·mm, 167.01±4.46 g·mm, 153.26±6.21 g·mm, 125.17±2.63 g·mm, 182.172±2.588 g·mm and 162.117±3.023 g·mm. The results, as shown in FIG. 2, indicate that the gel strength of soft gel products of surimi tends to decrease with the increase in the addition of Pickering emulsion.

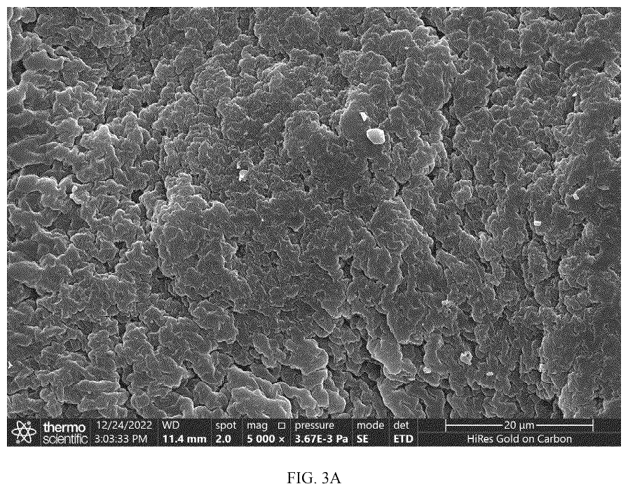

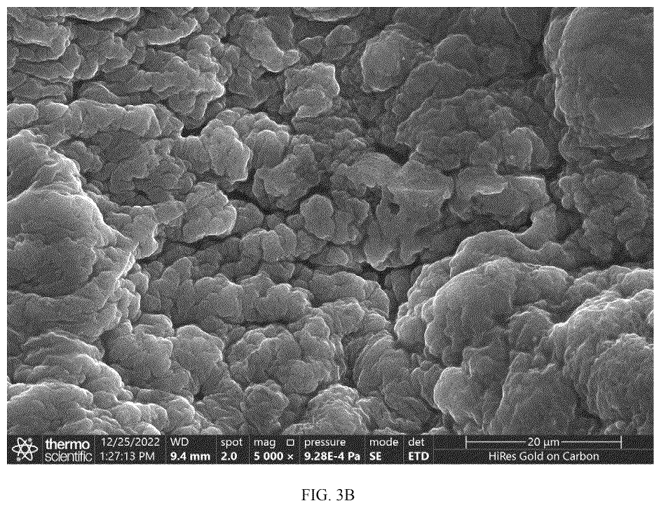

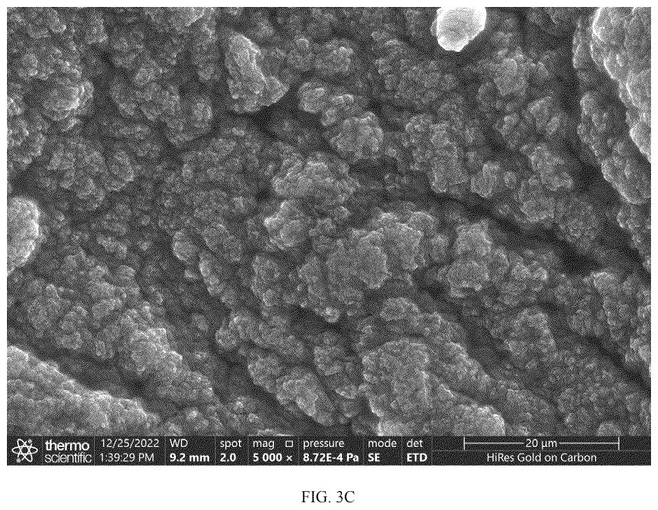

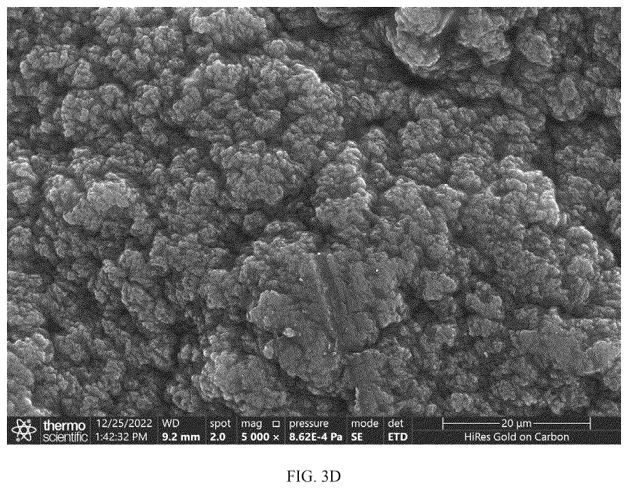

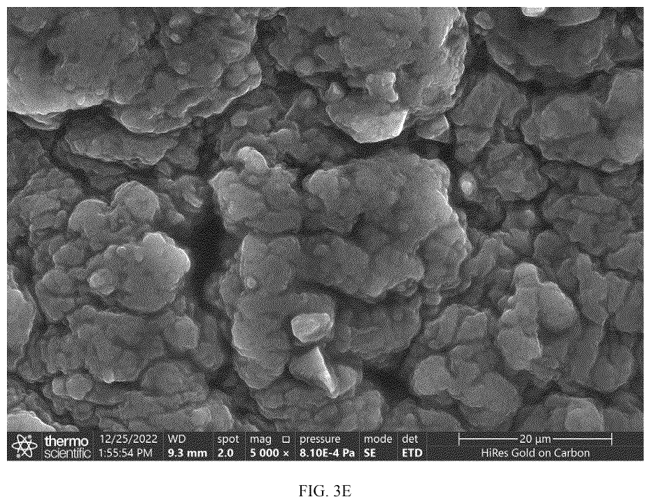

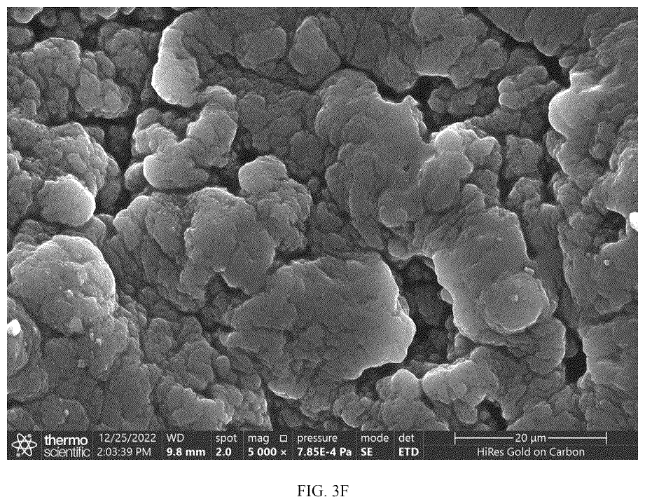

2. Microstructure of gel: scanning electron microscope (SEM) is used to observe each group of soft gel products of surimi added with Pickering emulsion of different mass in Embodiments 1-6. The soft gel products of surimi obtained in Embodiments 1-6 are made into thin slices with a thickness of 2 mm, soaked in glutaraldehyde solution with a volume fraction of 2.5% for 12 hours (h), then rinsed with 0.2 mol/L phosphate buffer (pH 7.2) for 3 times, 15 min each time, and then ethanol solutions with a volume fraction of 50%, 70% and 90% are prepared respectively to dehydrate the samples for 15 min in turn. Finally, the samples are dehydrated with anhydrous ethanol for 10 min and repeated for three times, and after gold plating using ion sputtering, the results are observed by scanning electron microscopy with a magnification of 5000 times, as shown in FIG. 3A-FIG. 3F, which reveals that with the increase of the amount of Pickering emulsion added to the gel, the pores on the structural surface of the gel increase, and the surface is rougher.

### Embodiment 7

The present disclosure relates to a preparation method of a soft gel product of surimi, which is different from Embodiment 1 only in that in step (2), 0.05% alkaline protease is added to the golden threadfin bream surimi. The remaining steps and parameters are the same as those in Embodiment 1. The step (2) specifically includes the following steps:

step (2): surimi thawing and pounding: the frozen surimi of golden threadfin bream is thawed in a cold storage or refrigerator at 4° C. for 12 h, then 0.05% alkaline protease is added to the thawed surimi below 10° C. and subjected to pounding for 2 min, then salt is added and subjected to pounding for another 2 min, and finally 1.5% (i.e., the mass fraction of the Pickering emulsion in the surimi is 1.5%) of the Pickering emulsion obtained in step (1) is added, as well as the auxiliary ingredients, including soy protein isolate, egg white powder, vegetable oil, potato starch, and so on, to continue pounding for 3 min;

among them, the addition amounts of salt, soy protein isolate, egg white powder, vegetable oil and potato starch are 1.5%, 0.5%, 1%, 2% and 10% of the weight of surimi, respectively.

### Embodiment 8

The present embodiment relates to a preparation method of a soft gel product of surimi, which is different from Embodiment 7 only in that a 3% fish oil Pickering emulsion obtained from step (1) is added to surimi of snapper in step (2), and the rest of the steps and parameters are the same as those in Embodiment 7.

### Embodiment 9

The present embodiment relates to a preparation method of a soft gel product of surimi, which is different from Embodiment 7 only in that 4.5% of fish oil Pickering emulsion obtained in step (1) is added to the surimi of belt fish in step (2), and the remaining steps and parameters are the same as those in Embodiment 7.

### Embodiment 10

The present embodiment relates to a preparation method of a soft gel product of surimi, which is different from Embodiment 7 only in that 6% of fish oil Pickering emulsion obtained in step (1) is added to the baby croaker surimi in the step (2), and the remaining steps and parameters are the same as those in Embodiment 7.

### Embodiment 11

The present embodiment relates to a preparation method of a soft gel product of surimi, which is different from Embodiment 7 only in that the fish oil Pickering emulsion obtained in step (1) is not added in step (2), and the remaining steps and parameters are the same as those in Embodiment 7.

### Embodiment 12

The present embodiment relates to a preparation method of a soft gel product of surimi, which is different from Embodiment 7 only in that adding 1.5% Pickering emulsion in step (2) is replaced by adding 1.5% silver carp oil.

The remaining steps and parameters are the same as those in Embodiment 7.

1. Determination of water-holding capacity of gel:

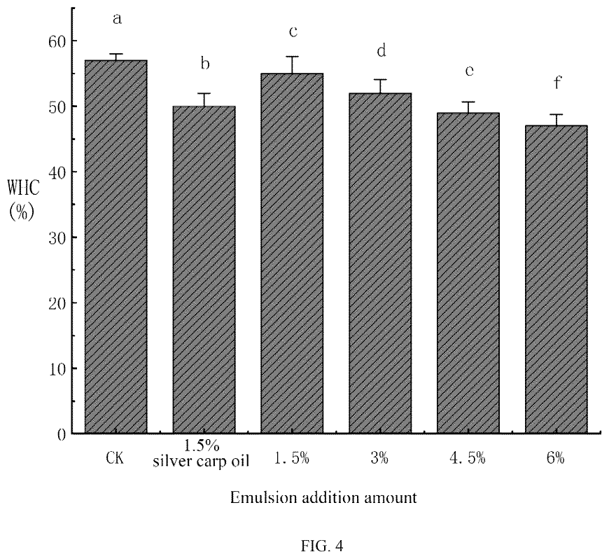

The water-holding capacity of soft gel product of surimi obtained in Embodiments 7-12 is determined by centrifugation: about 2 g of surimi gel sample (W₁, g) is weighed and placed between two layers of filter paper, wrapped and put into a 50 mL centrifuge tube and centrifuged (3000×g, 4° C.) for 15 min, the sample is taken out and weighed for the mass (W₂, g), and the water-holding capacity of surimi gel is calculated according to the following formula: WHC (%)=W₁/W₂×100. The results are shown in FIG. 4.

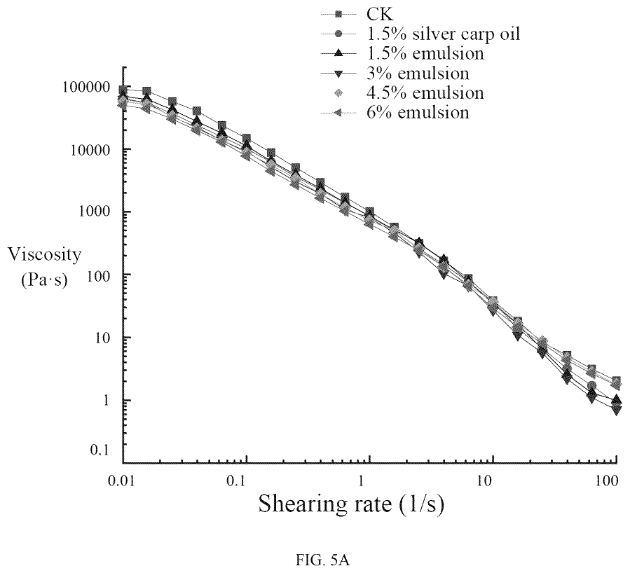

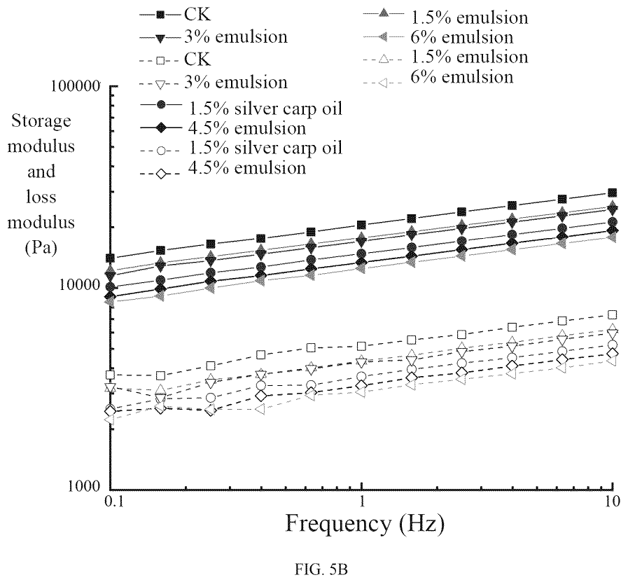

2. Determination of dynamic rheological properties of gel: dynamic rheological analysis is carried out on the soft gel products of surimi obtained in Embodiments 7-12; the unheated surimi lysate obtained from step (2) is taken and placed on the sample table with a gap of 1.0 mm between the plate and the carrier table; the experimental parameters are set as follows: strain 2%, oscillation frequency 0.1 Hz, heating scanning range 24-90° C., heating speed 3° C., and storage modulus (G′) and loss modulus (G″) during scanning are recorded. The results are shown in FIG. 5A and FIG. 5B, and it is observed that the viscosities of all groups gradually decrease with the increase of shear rate, indicating that the addition of Pickering emulsion deteriorates the network structure of soft gel, reduces the shear resistance of soft gel, and leads to the decrease of the viscosity. At the same time, the addition of Pickering emulsion reduces the G′ of soft gel, resulting in a lower gel strength of the soft gel.

### Embodiment 13

The present embodiment relates to a preparation method of a soft gel product of surimi, which is different from Embodiment 1 only in that 0.15% alkaline protease is added in step (2). The remaining steps and parameters are the same as those in Embodiment 1. Step (2) specifically includes the following steps:
step (2): surimi thawing and pounding: the frozen surimi is thawed in a cold storage or refrigerator at 4° C. for 12 h, then 0.15% alkaline protease is added to the thawed surimi below 10° C. and subjected to pounding for 2 min, then salt is added and subjected to pounding for another 2 min, and finally 1.5% (i.e., the mass fraction of the Pickering emulsion in the surimi is 1.5%) of the Pickering emulsion obtained in step (1) is added, as well as the auxiliary ingredients, including soy protein isolate, egg white powder, vegetable oil, potato starch, and so on, to continue pounding for 3 min; and
among them, the addition amounts of salt, soy protein isolate, egg white powder, vegetable oil and potato starch are 1.5%, 0.5%, 1%, 2% and 10% of the weight of surimi, respectively.

### Embodiment 14

The present embodiment relates to a preparation method of a soft gel product of surimi, which is different from Embodiment 13 only in that 3% of fish oil Pickering emulsion obtained in step (1) is added in step (2), and the remaining steps and parameters are the same as those in Embodiment 13.

### Embodiment 15

The present embodiment relates to a preparation method of a soft gel product of surimi, which is different from Embodiment 13 only in that 4.5% of fish oil Pickering emulsion obtained in step (1) is added in step (2), and the remaining steps and parameters are the same as those in Embodiment 13.

### Embodiment 16

The present embodiment relates to a preparation method of a soft gel product of surimi, which is different from Embodiment 13 only in that 6% of fish oil Pickering emulsion obtained in step (1) is added in step (2), and the remaining steps and parameters are the same as those in Embodiment 13.

### Embodiment 17

The present embodiment relates to a preparation method of a soft gel product of surimi, which is different from Embodiment 13 only in that the fish oil Pickering emulsion obtained in step (1) is not added in step (2), while the remaining steps and parameters are the same as those in Embodiment 13.

### Embodiment 18

The present embodiment relates to a preparation method of a soft gel product of surimi, which is different from Embodiment 13 only in that adding 1.5% Pickering emulsion in step (2) is replaced by adding 1.5% silver carp oil.

The remaining steps and parameters are the same as those in Embodiment 13.

### Technical Performance

the gel molecular force of the soft gel products of surimi obtained in Embodiments 11-16 is measured:

five solutions are prepared, i.e., 0.05 mol/L NaCl (Liquid A), 0.6 mol/L NaCl (Liquid B), 0.6 mol/L NaCl+1.5 mol/L urea (Liquid C), 0.6 mol/L NaCl+8 mol/L urea (Liquid D) 0.6 mol/L NaCl+8 mol/L urea+0.5 mol/L B-mercaptoethanol (Liquid E); 5 portions of each of the soft gel products of surimi obtained from Embodiments 9-12 are accurately weighed 2.0 g. The 5 identical samples of each embodiment are added to 10 mL of the above solutions of Liquid A-Liquid E, homogenized for 3 min, and then placed in 4° C. to stand for 1 h, then centrifuged at 8000 r/min for 30 min; then the supernatant is collected and measured in terms of protein content by Coomassie brilliant blue method. The protein contents of the solutions of Liquid A-Liquid E are represented by S1, S2 S3 and S4 respectively. Each sample is measured 3 times and averaged. The calculation method of ionic bond, hydrogen bond, hydrophobic interaction and disulfide bond contents is as follows:
ionic bond=S2-S1;
hydrogen bond=S3-S2;
hydrophobic interaction=S4-S3;
disulfide bond=S5-S4;

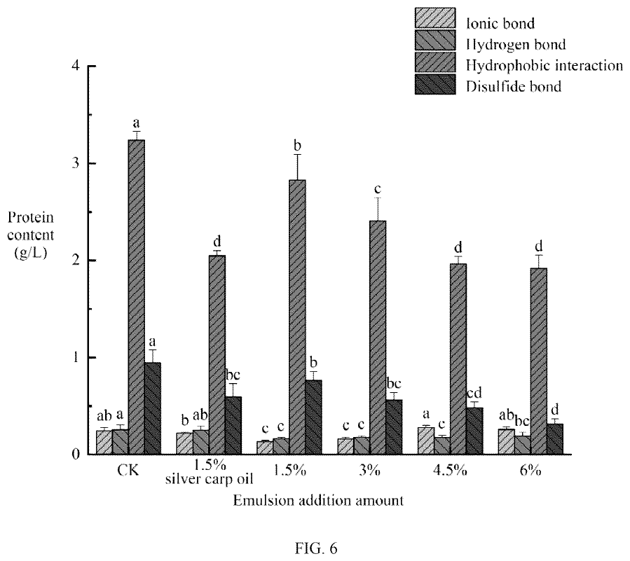

The results are expressed by the mass of dissolved protein per milliliter of solution (g/L). The results as shown in FIG. 6 suggest that the addition of Pickering emulsion may reduce the hydrophobic interaction and disulfide bond content of soft gel, thus reducing the gel strength and improving the softness.

The above describes only the preferred embodiments of this application, but the protection scope of this application is not limited to this. Any change or replacement that may be easily thought of by a person familiar with this technical field within the technical scope disclosed in this application should be included in the protection scope of this application. Therefore, the protection scope of this application should be based on the protection scope of the claims.

What is claimed is:

1. A soft gel product of surimi, comprising surimi, alkaline protease, fish oil Pickering emulsion and auxiliary materials.

2. The soft gel product of surimi according to claim 1, wherein a mass ratio of the surimi, alkaline protease and fish oil Pickering emulsion is 100:(0.05-0.15):(1.5-6).

3. The soft gel product of surimi according to claim 1, wherein the auxiliary materials comprise salt, soy protein isolate, egg white powder, vegetable oil and starch; and
a mass ratio of the salt, soy protein isolate, egg white powder, vegetable oil, potato starch and surimi is 1.5:0.5:1:2:10:100.

4. The soft gel product of surimi according to claim 1, wherein the surimi is one or more of silver carp surimi, golden threadfin bream surimi, snapper surimi, belt fish surimi and baby croaker surimi.

5. The soft gel product of surimi according to claim 1, wherein a preparation method of the fish oil Pickering emulsion comprises following steps:
mixing a fish oil and a modified starch dispersion according to an oil-water ratio of 0.5 w/w, adjusting an ionic strength using a sodium chloride solution, followed by homogenizing treatment to obtain the fish oil Pickering emulsion.

6. The soft gel product of surimi according to claim 5, wherein the modified starch comprises one of sodium octenyl succinate corn starch, sodium octenyl succinate cassava starch, cross-linked cassava starch, acetate cassava starch, hydroxypropyl cassava starch and hydroxypropyl phosphate corn starch.

7. The soft gel product of surimi according to claim 5, wherein a concentration of the modified starch dispersion is 4%;
a concentration of the sodium chloride solution is 0.4 Mole per liter; and
the homogenizing treatment comprises: firstly, treating using a high-speed homogenizer at 15000 revolutions per minute for 4 minutes, and then homogenizing by a high-pressure homogenizer at 50 Megapascals for 8 times.

8. The soft gel product of surimi according to claim 1, wherein a water content of the soft gel product of surimi is 75-85%.

9. A preparation method of the soft gel product of surimi according to claim 1, comprising following steps:
thawing the surimi, then adding protease for pounding for 2 to 4 minutes, then adding salt for pounding for another 2 to 4 minutes, and then adding Pickering emulsion and remaining auxiliary materials to continue pounding for 3 to 5 minutes, and finally, molding the surimi, gelatinizing the surimi by two-stage heating, and cooling to obtain the soft gel product of surimi.

10. The preparation method of the soft gel product of surimi according to claim 9, wherein a temperature of the pounding is 0-10 degrees Celsius; and
the two-stage heating is: heating at 40 degrees Celsius for 20 minutes, then heating to 90 degrees Celsius and heating for 30 minutes.
